(19) United States
(12) Patent Application Publication
(10) Pub. No.: US 2009/0229767 A1
(43) Pub. Date: Sep. 17, 2009

(54) Storm curtain side retention system

(76) Inventors: Willis J. Mullet, Gulf Breeze, FL (US); Richard S. Hand, Pace, FL (US); Darrin W. Brunk, Pensacola, FL (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 12/075,551

(22) Filed: Mar. 12, 2008

(51) Int. Cl. E06B 9/58; E06B 9/00

(52) U.S. Cl. 160/26; 160/38

(57) ABSTRACT

A curtain assembly (10) to cover and protect an opening in a structure, such as a window (11), includes side rails (14) which extend between a header (12) and a sill (13). A roller (19) is positioned in the header (12) and carries a fabric curtain (15). Tabs (20) extend outwardly from the lateral edges (18) of the curtain (15), and at least some of the tabs (20) carry at least one retention member (21, 22 or 23). Tabs (15) and the retention members (21, 22 or 23) are received in a compartment (39) in the side rails (14). Flap walls (40, 52) form a portion of the compartments (39) and are spaced from each other. The curtain (15) can extend through the space (56) but the retention members (21, 22 or 23) cannot. As a result, upon impact against the curtain, the retention members (21, 22 or 23) engage the flap walls (40, 52) which engage the curtain (15) and the curtain (15) is maintained in the side rails (14). Because the tabs (20) extend outwardly beyond the lateral edges of the roller (19), no additional space is taken up by the retention members (21, 22 or 23) when the curtain (15) is rolled up on the roller (19).

### TECHNICAL FIELD

This invention relates to a curtain assembly which protects a building from damage due to the breach of an opening in the building caused by high winds and wind-borne debris oftentimes present during storm conditions. More specifically, this invention relates to a system for maintaining the side edges of a curtain in the side rails of the assembly.

### BACKGROUND ART

In geographic areas which are prone to having high wind events, such as hurricanes and the like, the need exists for the protection of openings, such as windows and doors, in buildings. Otherwise, if the high winds or wind-borne debris breaches the integrity of the structure by destroying a window or door, severe damage to the structure can be expected.

One type of simple protection device involves the use of a sheet of plywood which can be attached to the structure so as to cover the openings thereof. However, this “boarding up” procedure is not only time consuming, when time is usually of the essence, but also can disfigure the exterior of the structure upon frequent installation and removal. Moreover, the plywood solution creates dark environments, and the weight, size, and limited shapes of the sheets often make deployment difficult, especially in windy conditions. In addition, plywood deteriorates with time, and storing and maintaining an inventory of plywood sheets can be problematic.

As a result, a number of temporarily installable or permanently installed devices have been developed to be used as alternatives to plywood. For example, metallic shutters consisting of a plurality of hinged slats can be provided adjacent to a window and can be rolled up by a hand crank or a motor when not in use. However, these devices are not only costly, but also the lateral edges thereof do not provide a proper seal.

More recently, fabric-based systems have been developed which can be less costly than the metallic shutters or other devices, and which can provide a seal for the openings in the structure. In their simplest form, these systems include a sheet of fabric which is strong enough to withstand high winds and the forces of wind-borne debris without rupturing. These fabric sheets may be attached across the opening on at least two edges, thus providing protection for the structure against the wind even if the glass of a window, for example, has been broken.

In most of these systems, the fabric curtain is stored on a roller carried in a header, and when it is desired to use the curtain to cover the opening, it is payed out from the roller and locked in place at the sill area or at the bottom of the opening. In addition to being required to be locked in place at the bottom, the manner in which the edges of the fabric are maintained in the side rails which extend vertically between the header and the sill is important to the operation of the system. In some elaborate systems, the force of wind or debris impacting the curtain will lock or otherwise seal the fabric edges in the side rails. However, in other systems it is possible that such forces will merely displace the fabric out of the side rails, and the need, therefore, exists for a system which will retain the position of the edge of the fabric in the side rails while allowing vertical movement. Moreover, it would be desirable to eliminate the need for locking the fabric at the bottom sill area and relying only on the connection to the side rails to maintain the curtain in place.

### DISCLOSURE OF THE INVENTION

It is thus an object of the present invention to provide a storm curtain which can be used to cover an opening in a structure thereby protecting the structure.

It is an object of another aspect of the present invention to provide an assembly, as above, with a system which retains the side edges of the curtain in the side rails of the assembly.

It is an object of another aspect of the present invention to provide an assembly, as above, which may eliminate the need to lock the fabric in the sill area at the bottom of the opening.

These and other objects of the present invention, as well as the advantages thereof over existing prior art forms, which will become apparent from the description to follow, are accomplished by the improvements hereinafter described and claimed.

In general, a curtain assembly to cover an opening in a structure made in accordance with one aspect of the present invention includes opposed side rails adapted to be generally vertically positioned along the sides of the opening. A curtain having longitudinally spaced ends and laterally spaced edges is generally vertically moveable between the side rails. A plurality of longitudinally spaced tabs extend outwardly from the edges of the curtain, and at least one retention member is carried by at least some of the tabs. The retention members are positioned in the rails to maintain the edges of the curtain in the rails.

In accordance with another aspect of the invention, a curtain assembly to cover an opening in a structure includes opposed rails adapted to be generally vertically positioned along the sides of the opening. A curtain is generally vertically moveable between the rails and has longitudinally spaced at ends and laterally spaced edges. A plurality of longitudinally spaced tabs extend outwardly from the edges of the curtain, at least some of which carry at least one retention member. A first flap is positioned in each rail and has a tip, and a second flap is positioned in each rail and has a tip. The second flap extends angularly toward the first flap such that a space is formed between the tips of the flaps. The space is large enough to allow the curtain to pass therethrough but not large enough to allow the retention members to pass therethrough.

A curtain for covering an opening in a structure made in accordance with the present invention includes a fabric material having longitudinally spaced ends and laterally spaced edges. One of the ends is adapted to be attached to a roller, and a plurality of longitudinally spaced tabs extend outwardly from the edges. At least one retention member is carried by at least some of the tabs, the retention members being adapted to maintain the fabric covering the opening.

A storm curtain side retention system made in accordance to the concepts of the present invention is shown by way of example in the accompanying drawings without attempting to show all the various forms and modifications in which the invention might be embodied, the invention being measured by the appended claims and not by the details of the specification.

### BRIEF DESCRIPTION OF THE DRAWINGS

FIG. 1 is a perspective view of a storm curtain assembly of the present invention shown as protecting the window of a structure.

FIG. 2 is a fragmented perspective view of a broken away corner of the header at the top of one of the side rails and showing a curtain side edge retention system in accordance with one embodiment of the present invention.

FIG. 3 is a fragmented top plan view of that which is shown in FIG. 2.

FIG. 4 is an elevational view of a curtain made in accordance with the present invention and having the side edge retention system shown in FIG. 2.

FIG. 5 is a sectional view taken substantially along line 5-5 of FIG. 4.

FIG. 6 is a partial sectional view taken substantially along line 6-6 of FIG. 1 and showing the side edge retention system shown in FIG. 2.

FIG. 6A is a view like FIG. 6 but showing the side retention system shown in FIG. 7.

FIG. 6B is a view like FIG. 6 but showing the side retention system shown in FIG. 8.

FIG. 7 is a fragmented perspective view of a broken away corner of the header at the top of one of the side rails and showing a curtain side edge retention system in accordance with a second embodiment of the present invention.

FIG. 8 is a fragmented perspective view of a broken away corner of the header at the top of one of the side rails and showing a curtain side edge retention system in accordance with a third embodiment of the present invention.

### PREFERRED EMBODIMENT FOR CARRYING OUT THE INVENTION

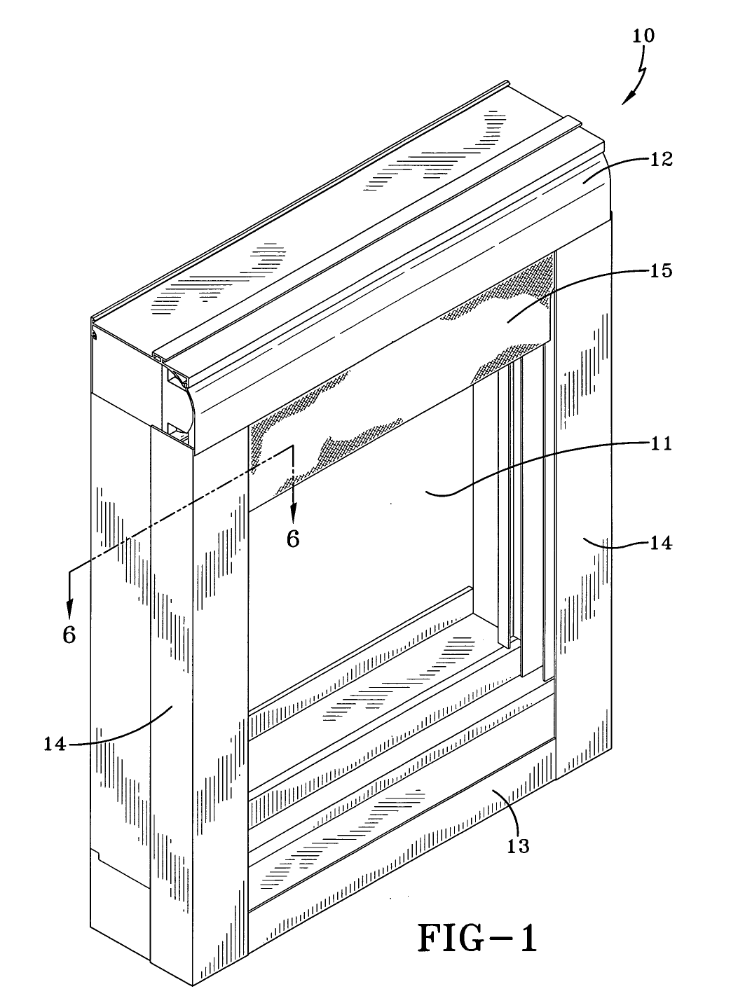

A storm curtain assembly made in accordance with the present invention is indicated generally by the numeral 10 in FIG. 1 and is adapted to be used to cover an opening, such as a window 11 of a structure. Assembly 10 can be positioned on the outside of the structure or on the inside thereof and includes an upper header 12 which extends across the top of window 11 and a lower sill 13 which extends across the bottom of the window 11. Laterally spaced side rails 14 extend vertically between the lateral edges of header 12 and sill 13.

As shown in FIG. 4, a curtain 15 has an upper end 16 longitudinally spaced from a lower end 17 and has opposed laterally spaced side edges 18. Curtain 15 can be made of any suitable material having a strength to protect opening and is preferably formed of a fabric material as disclosed in U.S. patent application Ser. No. 11/190,114 to which reference is made for whatever details may be necessary to fully understand the present invention. The upper end 16 of curtain 15 is attached to a roller 19 rotatably positioned in header 12, and curtain 15 is rolled up and stored on roller 19 when not in use. The lower end 17 of curtain 15 is usually provided with a bar (not shown) that is received in sill 13 and in the bottom of side rails 14 when the curtain is covering window 11. The curtain 15 may be locked at the sill 13 in this down position, if necessary, by a system such as that disclosed in U.S. patent application Ser. No. 11/799,298 to which reference is made for whatever details may be necessary to fully understand the present invention. However, as will hereinafter become evident, it has been found that by utilizing the storm curtain assembly 10 as described herein, the need to lock curtain 15 at sill 13 may not be necessary.

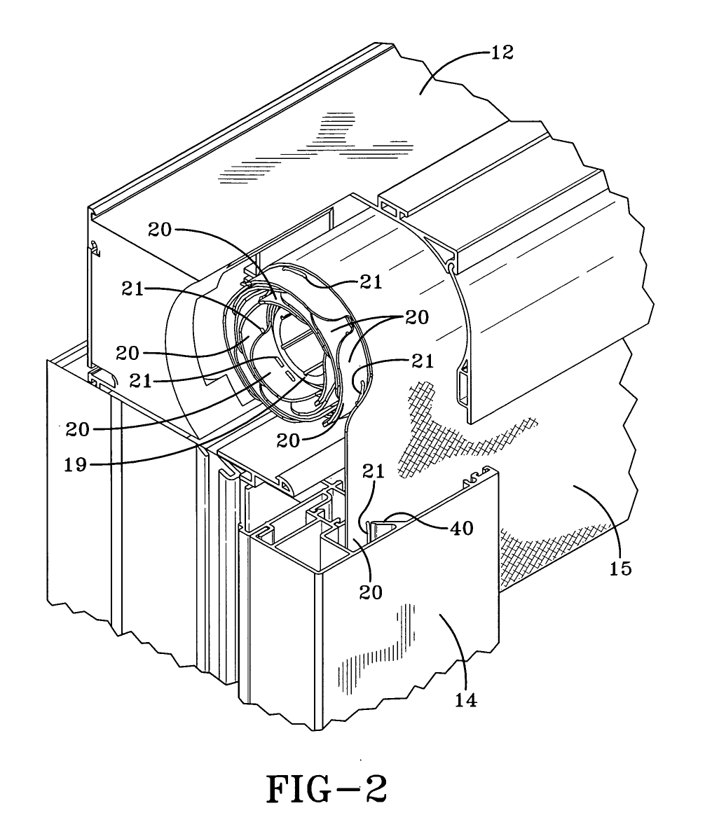

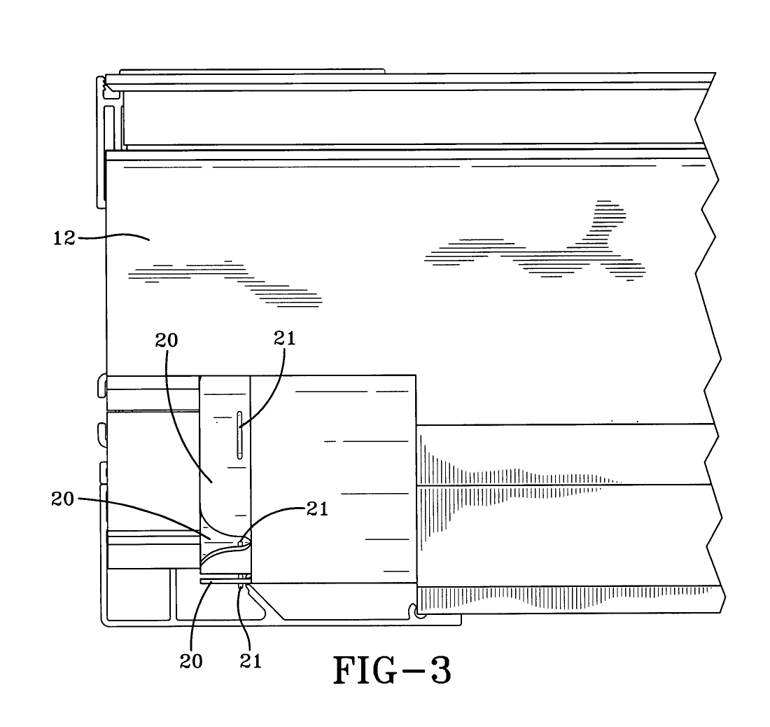

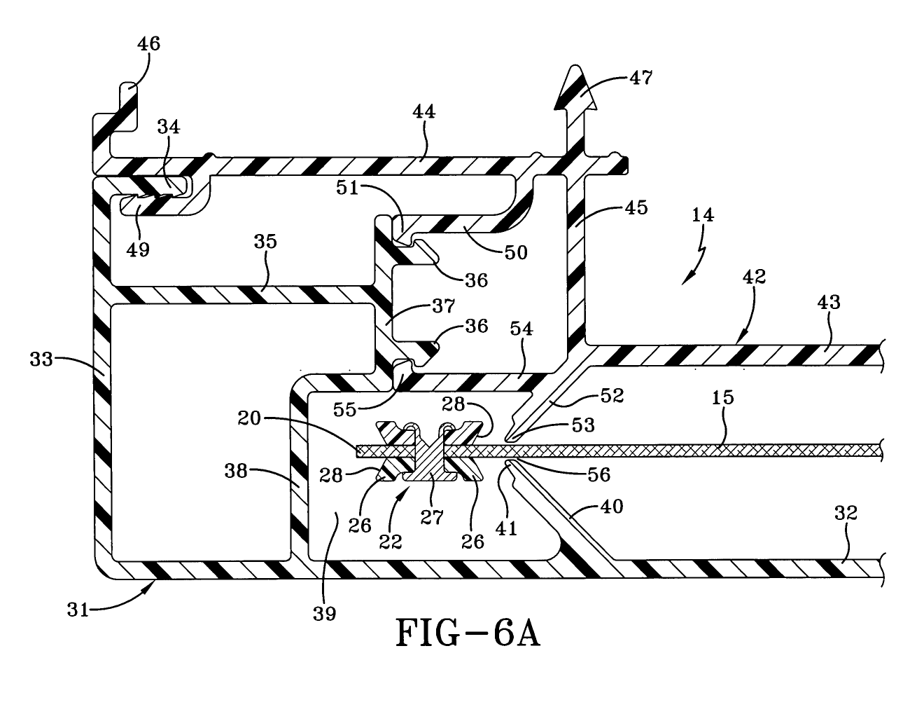

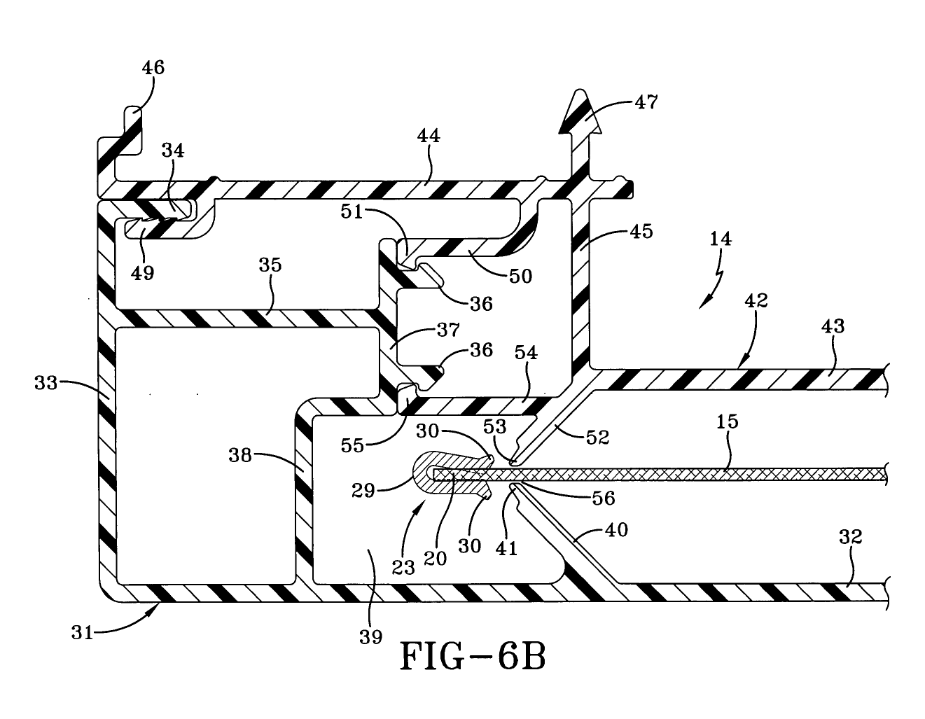

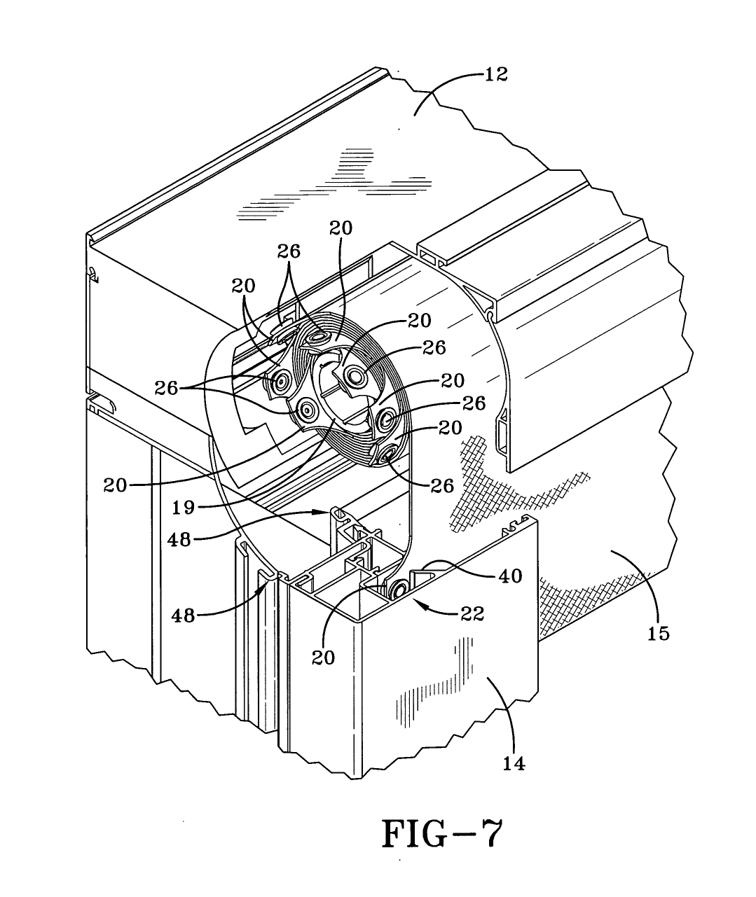

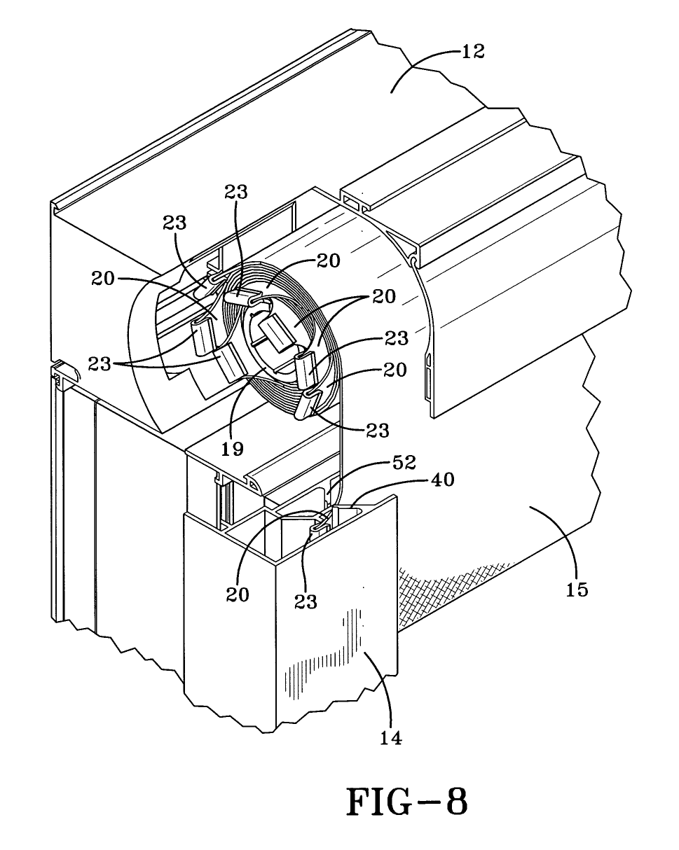

The side edges 18 of curtain 15 are provided with a plurality of longitudinally spaced tabs 20 which extend laterally outward from edges 18. Tabs 20 are adapted to receive retention members. As will hereinafter be described in more detail, three embodiments of retention members are shown in the drawings. Staple-like retention members are shown in FIGS. 2-6 and are indicated generally by the numeral 21; rivet-like retention members are shown in FIGS. 6A and 7 and are indicated generally by the numeral 22; and clip-like retention members are shown in FIGS. 6B and 8 and are indicated generally by the numeral 23. It should be noted that while it is preferred that all tabs 20 receive a retention member, it is not absolutely necessary that every tab 20 has such a member. Moreover, tabs 20 are sized so as to possibly receive more than one retention member 21, 22 or 23 if desired. In addition, if a single retention member on a tab were damaged, the size of the tabs permits a new retention member to be positioned at a different location on a tab than the damaged retention member.

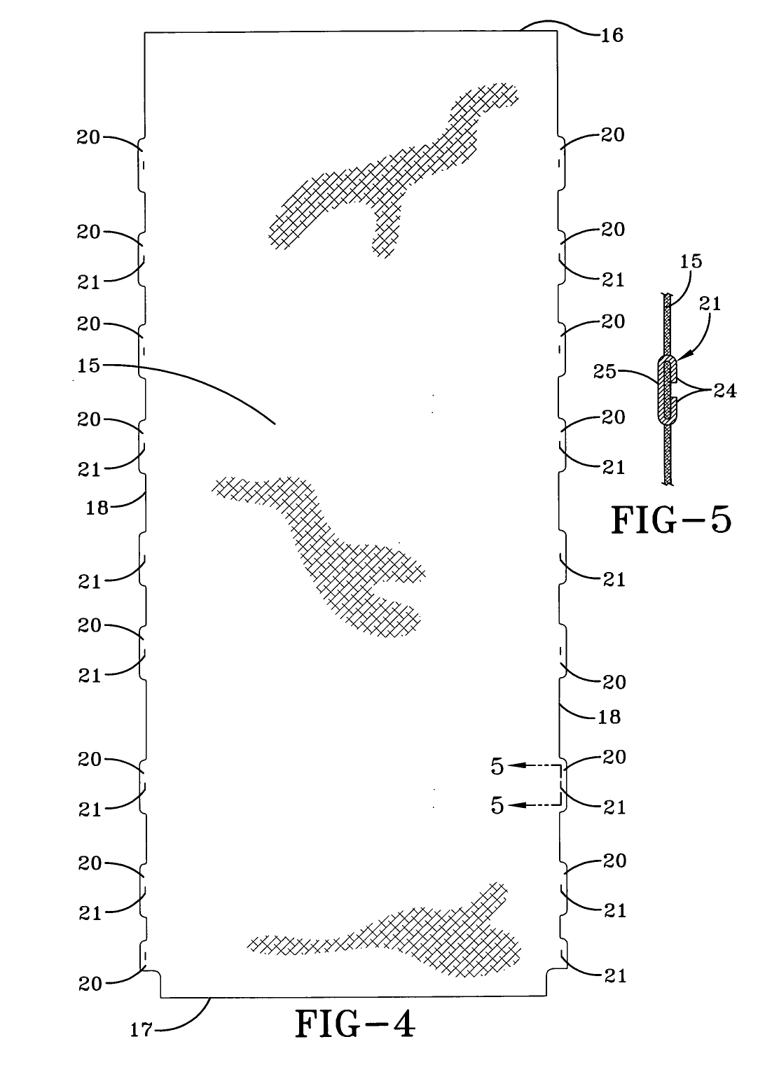

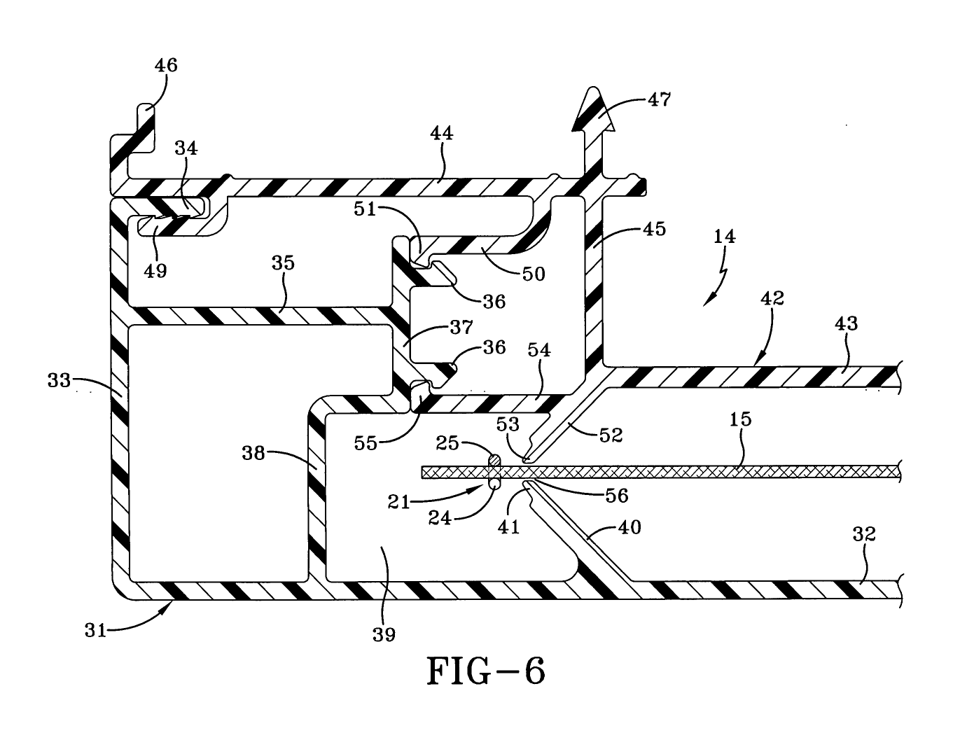

Each staple-like retention member 21 is formed of a round metallic wire preferably about one inch in total length and of a diameter of preferably about 0.054 inch. However, a member 21 having a length in the range of about one-half inch to about one and one-half inches and a diameter of about 0.040 to about 0.080 inch could be utilized. The wire material is then installed through the tabs 20 such that two hook portions 24 are formed on one side of each tab 20 which are interconnected by a body portion 25 on the other side of each tab 20, as best seen in FIG. 5. As such, members 21 take on the general configuration of an installed staple.

As best shown in FIGS. 6A and 7, each rivet-like retention member 22 is formed with opposed disks 26 and a rivet pin 27 which extends through an opening in each tab 20 and engages disks 26. Disks 26 are formed with a recessed outer surface 28 as will hereinafter be more fully described.

As best shown in FIGS. 6B and 8, each clip-like retention member 23 is preferably formed of a metallic material, such as spring steel, and includes a U-shaped body 29, the edge of each tab 20 being positioned the arms of body 29. Thus, tabs 20 are not penetrated but rather the spring force of members 23 hold them in place on the edge of the tab 20. A small hook 30 may be formed on the ends of the arms of the U-shaped body 29 as will hereinafter be more fully described.

The retention members 21, 22, or 23 are received within the side rails 14 of storm curtain assembly 10 in a manner shown in FIGS. 6, 6A and 6B. Each side rail 14 is preferably made of a light weight high strength metallic or non-metallic material and includes an outer frame generally indicated by the numeral 31 having a front face 32 and a side face 33 extending rearwardly from one end of front face 32. The side face 33 terminates as an inturned flange 34. A wall 35 extends inwardly from side face 33 between front face 32 and flange 34, and wall 35 carries hooks 36 positioned on a ledge 37. An extension 38 of ledge 37 is connected to front face 32 to provide stability to outer frame 31. Extension 38 also defines a portion of a compartment 39 into which the tabs 20 and retention members 21, 22 or 23 are received. A flap wall 40 extends angularly rearwardly from front face 32 and terminates at a notched lip 41. Wall 40 likewise defines a portion of compartment 39.

An intermediate frame is generally indicated by the numeral 42 and includes a front surface 43 and a rear surface 44 interconnected by a wall 45. One end of surface 44 is provided with a flange 46, and the other end is provided with a barb 47, both of which extend rearwardly to engage an inner frame (FIG. 7) generally indicated by the numeral 48 but not described in detail herein. A hook 49 extends inwardly from rear surface 44 near flange 46 and is adapted to engage flange 34 of outer frame 31. A wall 50 extends inwardly from rear surface 44 near barb 47 and has a lip 51 which engages one hook 36 of outer frame 31. A flap wall 52 extends angularly rearwardly from the junction of surface 43 and wall 45 and terminates at a notched tip 53. A wall 54 extends from flap wall 52 in a direction generally parallel to wall 50. Like wall 50, wall 54 has a lip 55 at its end which engages the other hook 36. Flap wall 52 and wall 54 also define a portion of compartment 39. Thus, intermediate frame 42 is attached to inner frame 48 via flange 46 and barb 47, and outer frame 31 is attached to intermediate frame 42 by the engagement of hook 49 with flange 32 and lips 51 and 55 with hooks 36.

Flap walls 40 and 52 oppose each other and their notched tips 41 and 53 are spaced slightly from each other, as at space 56, to allow the passage of fabric curtain 15. But space 56 is not large enough to allow the passage of retention members 21, 22 or 23 therethrough. Thus, as shown in FIGS. 6, 6A and 6B, in the normal use of curtain assembly 10, curtain 15 extends across the window 11 or other structural opening and into each side rail 14 between front face 32 of outer frame 31 and front surface 43 of intermediate frame 42. Curtain 15 then extends through the space 56 between flap walls 40 and 52. The lateral tab 20 ends of curtain 15, with a retention member 21, 22 or 23 attached thereto, are positioned in the compartment 39 of each side rail 14. As a result, the lateral edges of curtain 15 are maintained in the side rails 14 inasmuch as retention members 21, 22, or 23 cannot pass through space 56. In fact, during a high wind event causing deflection of curtain 15, retention members 21, 22, or 23 will be pulled against the tips 41 and 53 of flap walls 40 and 52, and can tend to cause flap walls 40 and 52 to flex toward each other narrowing the size of space 56 and actually gripping the curtain 15. The notch in tips 41 and 53 enhances such action as the portions 24 and 25 of retention member 21, the recessed outer surface 28 of disks 26 of retention member 22, or the hook 30 of retention members 23 engage and otherwise mate with the notches of tips 41 and 53. As a result of flap walls 40 and 52 tightly engaging curtain 15, the lateral edges of curtain 15 are sealed within side rails 14, and it has been found that this sealing force is sufficiently strong such that the need to lock the curtain 15 at the area of sill 13 may not be necessary, as previously described.

When curtain 15 is not being used to cover and protect window opening 11, it can be rolled up, either manually or by means of a motor, on roller 19. At this time, the lower end 17 of curtain 15 is still in the rails, as shown in FIGS. 6, 6A and 6B, but the vast majority of the curtain 15 is on the roller 19, as shown in FIGS. 2, 7 and 8. It should be noted that because the retention members 21, 22 or 23 are on the tabs 20 which extend laterally outward of curtain edges 18, the area required to store the curtain 15 on the roller 19 is not increased. That is, the diameter of the stored curtain is not increased by the presence of the retention members 21, 22, or 23 because these members are not positioned between wraps of curtain 15 on roller 19. Moreover, it should be noted from FIG. 4 that the longitudual spacing of tabs 20 is preferably not uniform. As a result, tabs 20 are at different circumferential locations around the stored roll, as shown in FIGS. 2, 7 and 8, so as not to interfere with each other. That is, the longitudinal spacing between tabs 20 is unevenly designed so that when on roller 19, tabs 20 will be at different circumferential locations.

In view of the foregoing, it should be evident that a storm curtain assembly constructed as described herein, accomplishes the objects of the present invention and otherwise substantially improves the art.

What is claimed is:

1. A curtain assembly to cover an opening in a structure comprising opposed rails adapted to be generally vertically positioned along the sides of the opening, a curtain generally vertically moveable between said rails, said curtain having longitudinally spaced ends and laterally spaced edges, a plurality of longitudinally spaced tabs extending outwardly from the edges of said curtain, at least one retention member carried by at least some of said tabs, a first flap having a tip positioned in each said rail, and a second flap having a tip positioned in each said rail, said second flap extending angularly toward said first flap such that a space is formed between said tips of said flaps, said space being large enough to allow said curtain to pass therethrough but not large enough to allow said retention members to pass therethrough.

2. The curtain assembly of claim 1, said flaps forming a portion of a compartment in said rails, said tabs and said retention members being received in said compartment and said curtain extending through said space.

3. The curtain assembly of claim 2 wherein when said curtain is exposed to a force, said retention members will engage said tips of said flaps to cause said flaps to engage said curtain.

4. The curtain assembly of claim 3 wherein said tips are notched to receive said retention members.

5. The curtain assembly of claim 1 wherein said first flap extends angularly toward said second flap.

6. The curtain assembly of claim 1 further comprising a roller attached to an end of said curtain such that said curtain may be rolled up on said roller, said roller having a lateral extent such that when said curtain is rolled up on said roller said tabs are positioned outside of the lateral extent of said roller.

7. The curtain assembly of claim 1 further comprising a roller attached to an end of said curtain such that said curtain may be rolled up on said roller, said tabs being unevenly longitudinally spaced along said edges of said curtain so that said tabs are circumferentially positioned differently when said curtain is rolled up on said roller.

8. The curtain assembly of claim 1 wherein said retention members are generally in the form of a staple having a body portion positioned on one side of said curtain and hooks connected to said body portion and positioned on the other side of said curtain.

9. The curtain assembly of claim 8, said flaps forming a portion of a compartment in said rails, said tabs and said staples being received in said compartment and said curtain extending through said space, such that when said curtain is exposed to a force, said body portion and said hooks will engage said tips of said flaps.

10. The curtain assembly of claim 1 wherein said retention members are generally in the form of a rivet.

11. The curtain assembly of claim 10, wherein said rivets include a disk positioned on each side of said curtain and a pin extending through said curtain and engaging said disks, said flaps forming a portion of a compartment in said rails, said tabs and said rivets being received in said compartment and said disks having a recessed outer surface, such that when said curtain is exposed to a force, said recessed outer surfaces of said disks will engage said tips of said flaps.

12. The curtain assembly of claim 1 wherein said retention members are generally in the form of a U-shaped clip having arms positioned on each side of said curtain, said tabs being received between said arms of said clips.

13. The curtain assembly of claim 12, said flaps forming a portion of a compartment in said rails, said tabs and said clips being received in said compartment and said curtain extending through said space, further comprising hooks formed at the end of said arms of said clips, such that when said curtain is exposed to a force, said hooks will engage said tips of said flaps.

14. A curtain for covering an opening in a structure comprising a fabric material having longitudinally spaced ends and laterally spaced edges, one of said ends being adapted to be attached to a roller, a plurality of longitudinally spaced tabs extending outwardly from said edges of said fabric material, and at least one retention member carried by at least some of said tabs, said members being adapted to maintain the fabric covering the opening.

15. The curtain of claim 14 which when said fabric is rolled up on the roller, said tabs are positioned outside of the lateral extent of the roller.

16. The curtain of claim 14, said tabs being unevenly longitudinally spaced along said edges of said fabric so that said tabs are circumferentially positioned differently when said fabric is rolled up on said roller.

17. The curtain of claim 14 wherein said retention members are generally in the form of staples.

18. The curtain of claim 14 wherein said retention members are generally in the form of rivets.

19. The curtain of claim 14 wherein said retention members are generally in the form of clips.

20. A curtain assembly to cover an opening in a structure comprising opposed rails adapted to be generally vertically positioned along the sides of the opening, a curtain generally vertically moveable between said rails, said curtain having longitudinally spaced ends and laterally spaced edges, a plurality of longitudinally spaced tabs extending outwardly from the edges of said curtain, and at least one retention member carried by at least some of said tabs, said retention members being positioned in said rails to maintain the edges of said curtain in said rails.
